(19) United States
(12) Patent Application Publication
(10) Pub. No.: US 2009/0195824 A1
(43) Pub. Date: Aug. 6, 2009

(54) IMAGE FORMING DEVICE

(75) Inventor: Shinji KAWASAKI, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Machinery, Ltd., Kyoto-shi (JP)

(21) Appl. No.: 12/362,866

(22) Filed: Jan. 30, 2009

(30) Foreign Application Priority Data
Feb. 1, 2008 (JP) 2008-022294

(51) Int. Cl. G06F 3/12

(52) U.S. Cl. 358/1.15

(57) ABSTRACT

An image forming device connected to a network includes a data administration unit, a creation source information generation unit, a raster data generation unit and a printer unit. The data administration unit stores printing data in a memory unit and generate identification data that identifies the printing data stored in the memory unit. The creation source information generation unit generates creation source information that specifies the own device as a creation source. The raster data generation unit rasterizes the printing data and generates raster data with the creation source information. The raster data with the creation source information includes the rasterized printing data, the identification data and the creation source information. The printer unit prints the raster data with the creation source information on a printing paper.

### CROSS-REFERENCE TO RERATED APPLICATIONS

This application claims priority under 35 U.S.C. 119 to Japanese Patent Application No. 2008-022294, filed on Feb. 1, 2008, which application is hereby incorporated by reference in its entirely.

### BACKGROUND OF THE INVENTION

1. Field of the Invention

The present invention relates to an image forming device arranged to store data to be printed on a printing document, and an image forming device arranged to print stored printing data in making a copy of a printed document.

2. Background Information

Conventionally, a digital Multi Function Peripheral (MFP), equipped with a printer function and a copy function or the like, has been commonly used in offices. In such digital MFP, the printer function makes it possible to print a document data or the like stored in a personal computer (PC), and the copy function makes it possible to create a copied document from the printed document. In making a copy, the digital MFP scans each page of a printed document and generates a plurality of image data corresponding to each page. A copied document is created by printing each image data on a printed paper in the same order as scanning each page of the printed document.

An image quality of a copied document created in the above-described procedure is usually deteriorated compared to that of the original printed document. However, it has been conventionally requested to prevent image deterioration of a copied document in making a copy of the printed document. Consequently, there is a digital MFP (M1) which maintains the same image quality of a copied document as that of the original document.

The digital MFP (M1) receives Page Description Languages (PDL) data from a PC as a print request and generates page data in which the PDL data is divided into each page. The digital MFP (Ml) stores each page data and then generates rasterized image data of each page data. A printed document is created by printing the image data to which identification data for each page is added. In making a copy, the digital MFP (M1) generates a plurality of scanned image data corresponding to each page of the printed document and obtains a plurality of identification data from each of the scanned image data. Page data corresponding to each identification data is printed in place of each scanned image data.

The above-described digital MFP (M1) prints PDL data corresponding to the printed document in creating a copied document. In this way, the digital MFP (M1) can create the copied document which has the same image quality as that of the printed document.

However, such digital MFP sometimes fails to make an exact copy of a printed document which has been created by another digital MFP (M2). This occurs in the case in which there is a difference in installed font data or the like between the digital MFP (M1) and the digital MFP (M2). Since conditions of generating raster data from PDL data are different between the digital MFP (M1) and the digital MFP (M2), appearances of the printed document and the copied document become different.

Whether the appearance of the copied document is the same as that of the printed document often turns out only after outputting the copied document. In the case in which the appearances of the printed document and the copied document created by the digital MFP (M1) differ, a user needs to create a printed document again by using another digital MFP (M2). Such digital MFP has may cause inconvenience to users.

### SUMMARY OF THE INVENTION

The present invention has been made in consideration of the above-described drawbacks and intended to provide an image forming device which can print the same raster data as that printed on a printed document.

In order to overcome the problems described above, according to one aspect of the present invention, an image forming device connected to a network is provided with a data administration unit arranged to store printing data in a memory unit and generate identification data that identifies the printing data stored in the memory unit, a creation source information generation unit arranged to generate information that specifies the own device as a creation source, a raster data generation unit arranged to rasterize the printing data and generate raster data with the creation source information which includes the rasterized printing data, the identification data and the creation source information, and a printer unit arranged to print the raster data with the creation source information on a printing paper.

Further, according to another aspect, the image forming device is provided with a setting information generation unit arranged to generate setting information for generating the raster data with the creation source information. The raster data with the creation source information includes the setting information.

Further, according to another aspect of the present invention, the image forming device connected to the network is provided with a data administration unit arranged to store printing data in a memory unit and generate identification data that identifies the printing data stored in the memory unit, a creation source information generation unit arranged to generate information that specifies the own device as a creation source, associated with the identification data, and then stores it in the memory unit, a raster data process unit arranged to rasterize the printing data and then generate raster data with the identification data which includes the rasterized printing data and the identification data, and a printer unit arranged to print the raster data with the identification data on a printing paper.

Further, according to another aspect of the present invention, a setting information generation unit arranged to generate setting information for generating the raster data with the identification data. The setting information is associated with the identification data. The setting information is stored in a memory unit.

Further, according to other aspect of the present invention, an original data obtaining unit, a setting information obtaining unit, a replicated data generation unit and a transmitting unit are provided. The original data obtaining unit arranged to receive the identification data from a communication device connected via the network and obtains the printing data stored in the memory unit as original data according to the received identification data. The setting information obtaining unit is arranged to obtain the setting information associated with the identification data. The replicated data generation unit is arranged to rasterize the original data according to the obtained setting information and generate replicated raster data including the rasterized original data. The transmitting unit transmits the replicated raster data to the communication device.

According to yet another aspect, the image forming device, connected to a printing device via the network, is provided with a scanner unit arranged to scan a printing paper on which printing data and identification data that identifies the printing data are printed and then generates scanned image data, an attribute information obtaining unit arranged to obtain the identification data from the scanned image data and creation source information that specifies the printing device, associated with the identification data, a rasterizing instruction unit arranged to specify the printing device based on the obtained creation source information and ask the printing device to generate raster data including the rasterized printing data by transmitting the obtained identification data to the printing device, and a printer unit arranged to receive the raster data generated by the printing device and prints the received raster data.

Further, according to still another aspect of the present invention, the attribute information obtaining unit has a setting information obtaining unit arranged to obtain setting information for a process of rasterizing of the printing data, associated with the identification data, and the rasterizing instruction unit has a transmitting unit arranged to transmit the identification data and the setting information to the printing device in order to make a request for generating the raster data by the printing device.

According to other aspect, the image forming device prints the raster data with the creation source information on a printing paper. The raster data with the creation source information includes the rasterized printing data, the information that specifies the own device as the creation source, and the identification data of the printing data stored in the memory unit. As a result, other printing device can ask the image forming device to generate the same raster data as that as the creation source information by using the identification data and the creation source information obtained by scanning the printing paper.

According to still other aspect, the image forming device also prints on a printing paper the raster data with the identification data including the rasterized printing data and the identification data, and then stores the creation source information in the memory unit. As a result, other printing device can ask the image forming device to generate the same raster data as that with the identification data by using the identification data obtained by scanning the printing paper and the creation source information obtained from the memory unit.

Therefore, with other printing device, a user can easily create the same document as the printed document created by the image forming device.

Further, according to still other aspect, the image forming device asks the printing device, i.e., the creation source of the printed document, to rasterize the printing data by using identification data obtained by scanning the printing paper and the creation source information associated with the identification data. In other word, the image forming device can obtain the same raster data as that printed on the printed paper. Therefore, with the image forming device, a user can easily create the same document as the printed document created by other printing device.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a schematic diagram of a network system including configurations of a printer and a network MFP according to the first embodiment of the present invention.

FIG. 2 is a flowchart illustrating the operation of a printer in a printing process.

FIG. 3 illustrates an example of combined raster data.

FIG. 4 is a flowchart illustrating the operation of a network MFP in a copying process.

FIG. 5 is a flowchart illustrating the operation of a printer in receiving a raster data transmission request.

FIG. 6 is a schematic diagram of a network system including configurations of a printer and a network MFP according to the second embodiment of the present invention.

### DETAILED DESCRIPTION OF THE EMBODIMENTS

### First Embodiment

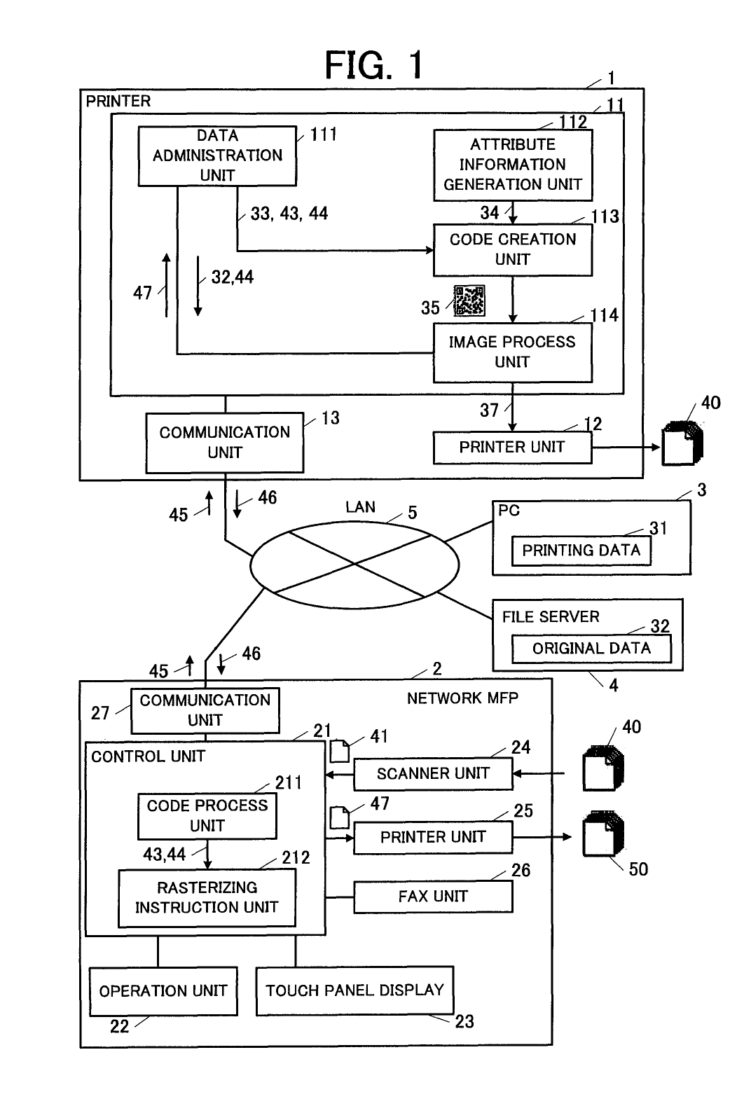

With reference to the drawings, the first embodiment of the present invention will be described. In this embodiment, a printer and a network MFP will be described as examples of an image forming device. FIG. 1 is a schematic diagram of a network system including configurations of a printer 1 and a network MFP 2.

A network system described in FIG. 1 includes a printer 1, a network MFP 2, a personal computer (PC) 3 and a file server 4, which are all connected to a local area network (LAN) 5.

The printer 1 is a network printer which outputs a printed document 40 based on a print instruction from the PC 3. The network MFP 2 is a multifunction device provided with a copy function, a printer function, a scanner function, a facsimile (FAX) function or the like. The PC is a terminal device used by a user. The file server stores original data 32 based on an instruction from the printer 1. The LAN 5 is provided with a router (not illustrated) to be connected to the Internet, other LAN or the like.

Next, the configuration of the printer 1 will be described. The printer 1 is provided with a control unit 11, a printer unit 12 and a communication unit 13.

The control unit 11 is provided with a data administration unit 111, an attribute information generation unit 112, a code creation unit 113, an image process unit 114 and a microprocessor (not illustrated). The microprocessor exercises the overall control of the printer 1.

The printer unit 12 creates the printed document 40, based on the print instruction transmitted from the PC 3. Between the communication unit 13 and the network MFP 2 and the PC 3 connected to the LAN 5, data is transmitted and received by using a protocol such as TCP/IP.

Next, each functional unit of the control unit 11 will be described. The data administration unit 111 stores as the original data 32 the printing data 31 received together with the print instruction in the file server 4, and then generates destination information 33 which indicates the destination to which the original data 32 is stored. The data administration unit 111 also obtains the original data 32 from the file server 4 based on a raster data transmission request 45.

The printing data 31 is data converted from text data or the like stored in the PC 3 into PDL data by a printer driver installed in the PC 3. The destination information 33 is the information that specifies the original data 32 and is described based on a format such as Uniform Resource Locator (URL).

The attribute information generation unit 112 generates attribute information 34 which includes conditions under which the printing data 31 is rasterized. The code creation unit 113 creates a two-dimensional code 35 which includes the destination information 33 and the attribute information 34. The image process unit 114 combines raster data 36, the rasterized data of the printing data 31, and the two-dimensional code 35.

As an example of the two-dimensional code 35, a QR code (registered trademark) is applicable. The code creation unit 113 may create a single-dimensional code (bar-code) instead of the two-dimensional code 35.

Next, the configuration of the network MFP 2 will be described. The network MFP 2 is provided with a control unit 21, an operation unit 22, a touch panel display 23, a scanner unit 24, a printer unit 25, a FAX unit 26 and a communication unit 27.

The control unit 21 is provided with a code process unit 211, a rasterizing instruction unit 212 and a microprocessor (not illustrated). The microprocessor controls the overall operation of the network MFP 2.

The operation unit 22 includes hardware keys or the like by which various kinds of instructions to the network MFP 2 is input. The touch panel display 23 displays information of the network MFP 2 and various kinds of operation menus. A user can perform the various kinds of the operation of the network MFP 2 by using the operation unit 22 and the touch panel display 23.

The scanner unit 24 scans the printed document 40 which is set at an auto document feeder (not illustrated) and then outputs scanned image data 41, 41 . . . corresponding to each page. The printer unit 25 prints image data or the like received by the FAX unit 26.

The FAX unit 26 performs a facsimile communication via a public network (not illustrated). Between the communication unit 27 and each computer connected to the LAN 5, the Internet or the like, data is transmitted and received by using a protocol such as TCP/IP.

Next, each functional unit of the control unit 21 will be described. The code process unit 211 extracts the two-dimensional code 35 from the scanned image data 41 and obtains various kinds of information recorded in the two-dimensional code 35.

The rasterizing instruction unit 212 specifies a printer which is a creation source of the printed document 40. The rasterizing instruction unit 212 generates the raster data transmission request 45 used for requesting a transmission of data corresponding to the printed document 40, and then transmits the request to the creation source of the printed document 40.

Next, the operations of the printer 1 and the network MFP 2 shown in FIG. 1 will be described. The below description will be made assuming that the printing data 31 is composed of a single page.

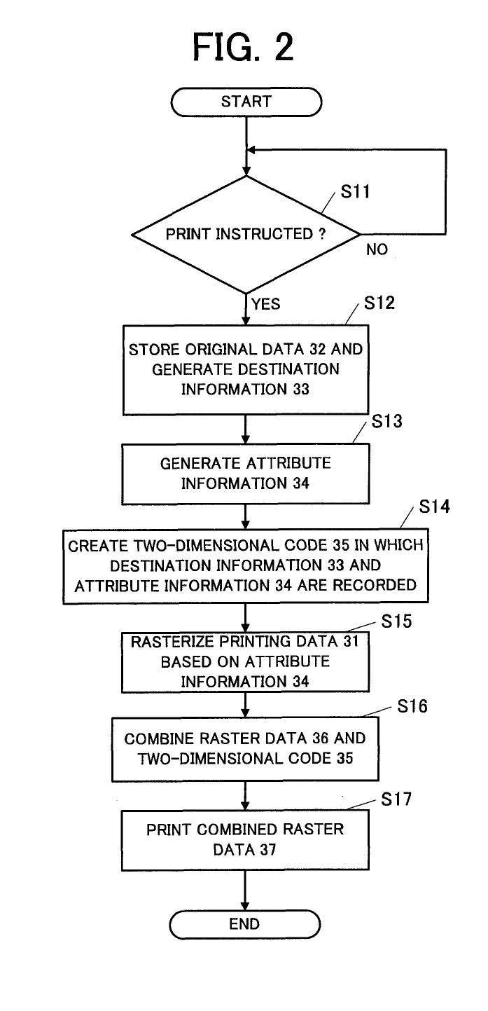

Firstly, the operation of the printer 1 in the printing process of the printing data 31 will be described. FIG. 2 is a flowchart illustrating the operation flow of the printer 1 in the printing process. The network MFP 2 is not engaged in the printing process of the printing data 31.

First, a user operates the PC 3 and instructs the PC 3 to print text data stored in the PC 3. The printer driver of the PC 3 converts the text data into PDL data to generate the printing data 31. The printing data 31 is transmitted from the PC 3 to the printer 1 via the LAN 5 together with a print instruction.

The control unit 11 of the printer 1 initiates the printing process of the printing data 31 upon receiving the print instruction and the printing data 31 via the communication unit 13 (Yes in Step S11). Specifically, the data administration unit 111 stores the printing data 31 as the original data 32 in the file server 4, and generates the destination information 33 which indicates the destination to which the original data 32 is stored (Step S12). The destination information 33 is passed to the code creation unit 113.

Next, the attribute information generation unit 112 generates the attribute information 34 including conditions under which the printing data 31 is rasterized (Step S13). The attribute information 34 is passed to the code creation unit 113.

The attribute information 34 includes information such as type information, creation source information, used font information. The type information indicates a format of the original data 32. In the case in which the original data 32 is PDL data, a used language name (such as PostScript) is recorded as type information. In the case in which the original data 32 is raster data, an indication of raster data (an image format name or the like such as tiff) is recorded as type information. The creation source information indicates a creation source of the printed document 40 in which an IP address, name and model name of the printer 1 are recorded. The used font information is the information which includes font type or the like actually used when the printing data 31 is rasterized.

Next, the code creation unit 113 creates the two-dimensional code 35 which includes the destination information 33 and the attribute information 34 (Step S14). The image process unit 114 rasterizes the printing data 31 based on the attribute information 34 (Step S15) to generate the raster data 36. The combined raster data 37 is generated by combining the two-dimensional code 35 and the raster data 36 (Step S16).

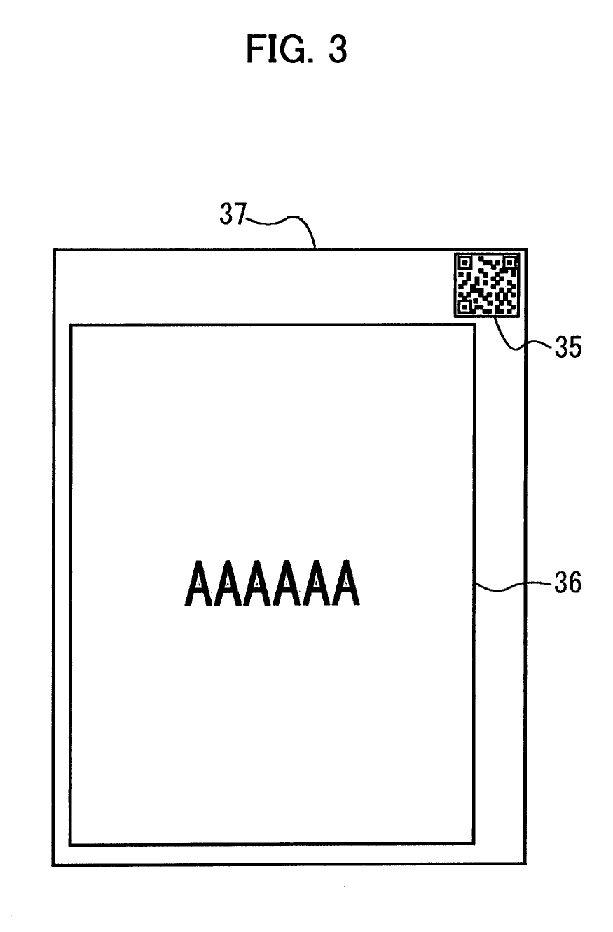

FIG. 3 illustrates an example of the combined raster data 37. As illustrated in FIG. 3, in the combined raster data 37, the two-dimensional code 35 and the raster data 36 are allocated in the positions not to overlap one another. Depending on a size of a printing paper, the two-dimensional code 35 can not be allocated in a margin of the raster data 36. In this case, the image process unit 114 may reduce the raster data 36 and combine the two-dimensional code 35 and the reduced raster data 36.

The printer unit 12 prints the combined raster data 37 generated by the image process unit 114 (Step S17) to output the printed document 40. In this way, on the printed document 40, the attribute information 34 and the destination information 33 are printed in the form of the two-dimensional code 35. The attribute information 34 indicates the conditions under which the printed document 40 is created. The destination information 33 indicates the destination to which the original data 32 corresponding to the printed document 40 is stored.

In Step S12, the data administration unit 111 may store the raster data 36 as the original data 32 in the file server 4. In this case, among processes of Step S12, storing the original data 32 is performed after the process of Step S15. Further, in Step S13, the type information and the creation source information are recorded in the attribute information 34.

Next, the operations of the printer 1 and the network MFP 2 when the network MFP 2 creates the same document as the printed document 40 will be described. The same document as the printed document 40 is called a copied document 50 for convenience. Not only the network MFP 2 but also the printer 1 is engaged in creating the copied document 50.

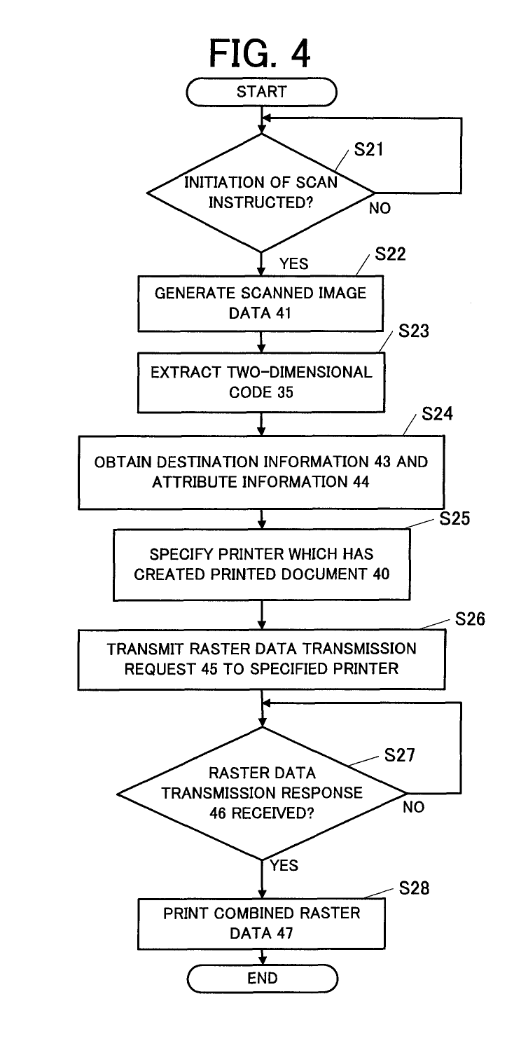

Firstly, the operation of the network MFP 2 in the creating process of the copied document 50 will be described. FIG. 4 is a flowchart illustrating the operation flow of the network MFP 2 in the creating process of the copied document 50.

First, a user sets the printed document 40 at an auto document feeder (not illustrated) in the scanner unit 24. The user operates the operation unit 22 or the touch panel display 23 for a setting related to creation of the copied document 50.

After the above-described setting, the user inputs an instruction to initiate a scan by operating the operation unit 22 or the touch panel display 23. The scanner unit 24, based on the instruction to initiate a scan (Yes in Step S21), scans the printed document 40 to generate the scanned image data 41 (Step S22).

The code process unit 211 extracts the two-dimensional code 35 from the scanned image data 41 (Step S23). The code process unit 211 analyzes the two-dimensional code 35 and obtains the destination information 43 and the attribute information 44 recorded in the two-dimensional code 35 (Step S24). The destination information 33 is the same as the destination information 43, and the attribute information 34 is the same as the attribute information 44. The destination information 43 and the attribute information 44 obtained by the code process unit 211 are passed to the rasterizing instruction unit 212.

The rasterizing instruction unit 212, based on the creation source information included in the attribute information 44, specifies the printer 1 as the printer which has created the printed document 40 (Step S25). The rasterizing instruction unit 212 generates the raster data transmission request 45 and transmits the raster data transmission request 45 to the printer 1 (Step S26). The raster data transmission request 45 includes the destination information 43 and the attribute information 44.

In the case in which the rasterizing instruction unit 212 receives a raster data transmission response 46 from the printer 1 (Yes in Step S27), the rasterizing instruction unit 212 instructs the printer unit 25 to print the combined raster data 47 included in the raster data transmission response 46. The printer unit 25 prints the combined raster data 47 (Step S28) to output the copied document 50.

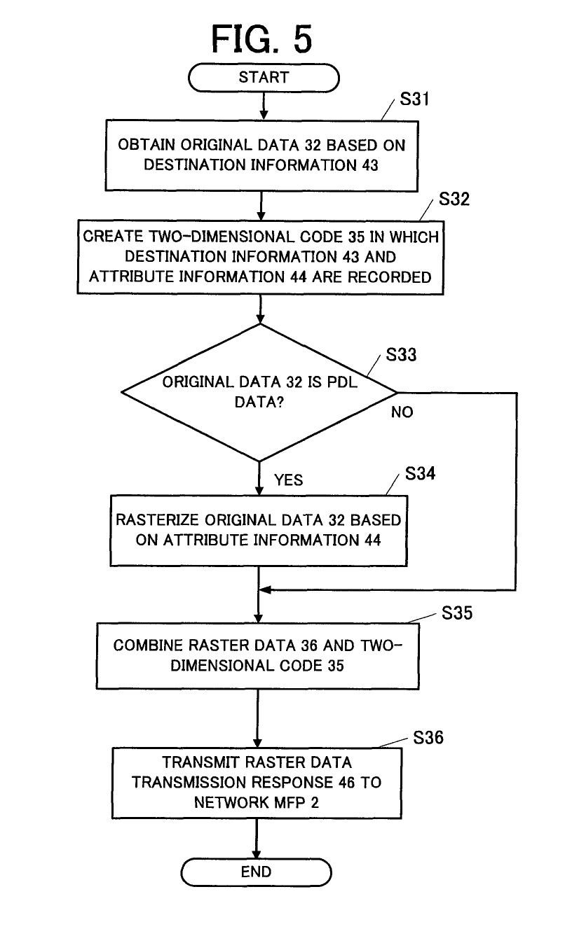

Next, the operation of the printer 1 in receipt of the raster data transmission request 45 will be illustrated. FIG. 5 is a flowchart illustrating the operation of the printer 1 in a response process to the raster data transmission request 45.

The control unit 11 of the printer 1 initiates processes illustrated in FIG. 5 upon receiving the raster data transmission request 45 via the communication unit 13. The data administration unit 111 extracts the destination information 43 and the attribute information from the raster data transmission request 45. The data administration unit 111 obtains the original data 32 from the file server 4 according to the destination information 43 (Step S31). The code creation unit 113 creates the two-dimensional code 35 from the destination information 43 and the attribute information 44 (Step S32).

The image process unit 114 refers to the type information in the attribute information 44 and determines whether the original data 32 is PDL data or the raster data 36 (Step S33). In the case in which the original data 32 is the raster data 36 (No in Step S33), the process of the image process unit 114 proceeds to Step S35. On the other hand, in the case in which the original data 32 is PDL data (Yes in Step S33), the image process unit 114, based on the attribute information 44, rasterizes the original data 32 (Step S34) to generate the raster data 36.

The image process unit 114 generates the combined raster data 47 from the raster data 36 and the two-dimensional code 35 (Step S35). The combined raster data 47 is the same data as the combined raster data 37 illustrated in the FIG. 3. The data administration unit 111 transmits the combined raster data 47 as the raster data transmission response 46 to the network MFP 2 (Step S36). In other words, the printer 1 performs the same processes as those illustrated in Step S14 through S17 as a response process to the raster data transmission request 45.

As above-described, according to the present embodiment, the network MFP 2, in creating the copied document 50, allows the printer 1 to generate the combined raster data 47 which is the same as the combined raster data 37 printed on the printed document 40. In this way, a user can easily create the copied document 50 which is the same as the printed document 40, with the network MFP 2 which is different from the printer 1 by which the printed document 40 has been created.

Further, the printer 1 records, in the two-dimensional code 35 to be printed on the printed document 40, the destination information 33 of the original data 32 corresponding to the printed document 40 and the attribute information 34 including conditions under which the raster data 36 is created. In this way, the printer 1 can easily generate the combined raster data 47 which is the same as the combined raster data 37 printed on the printed document 40.

### Second Embodiment

With reference to the drawings, the second embodiment of the present invention will be described. In this embodiment, a printer and a network MFP will be described as an example of an image forming device according to the present invention.

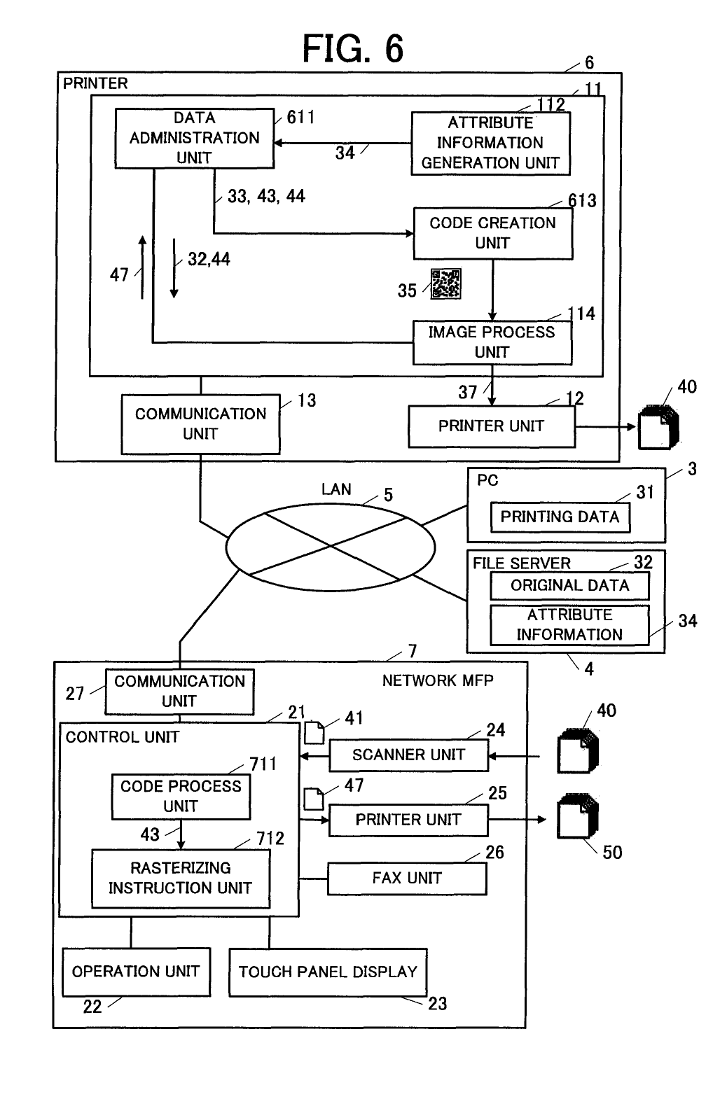

FIG. 6 is a schematic diagram of a network system including configurations of the printer 6 and the network MFP 7. In the case in which a configuration illustrated in FIG. 6 is the same as that of FIG. 1, the same number is shared between FIG. 1 and FIG. 6 to indicate the same configuration. Therefore, a detailed description will not be made for such configuration.

As illustrated in FIG. 6, the major difference between the second embodiment and the first embodiment of the present invention is that the attribute information is stored in the file server 4, associated with the original data 32. As a result, in the printing process of the printing data 31, only the destination information is recorded in the two-dimensional code 35. Further, in the creation process of the copied document 50, the network MFP 7 obtains the attribute information 34 from the file server 4.

Next, referring mainly to the differences from the printer 1 and the network MFP 2 according to the first embodiment, the printer 6 and the network MFP 7 according to the present embodiment will be described.

First, configurations of the printer 6 and the network MFP 7 will be described. The control unit 11 of the printer 6 is provided with a data administration unit 611 and a code creation unit 613, instead of the data administration unit 111 and the code creation unit 113. The control unit 21 of the network MFP 7 is provided with a code process unit 711 and a rasterizing instruction unit 712, instead of the code process unit 211 and the rasterizing instruction unit 212.

Next, the operation of the printer 6 in the printing process of the printing data 31 will be described, referring mainly to a difference from the process illustrated in FIG. 2. First, the printer 6 performs the same processes as those described in Step S11 through S13. After the process illustrated in Step S13, the attribute information generation unit 112 passes the attribute information 34 to the data administration unit 611. The data administration unit 611 associates the attribute information 34 with the original data 32, and stores the corresponded attribute information 34 and the original data 32 in the file server 4.

The code creation unit 613 creates the two-dimensional code 35 which includes the destination information 33, instead of the process illustrated in Step S14. Then, the printer 6 performs the processes described in Step S15 through S17 to output the printed document 40. In this way, according to the present embodiment, on the printed document 40, the two-dimensional code 35 which includes only the destination information 33 is printed.

Next, the operation of the network MFP 7 in the creation process of the copied document 50 will be described. In the creation process of the copied document 50, the printer 6 performs the processes illustrated in FIG. 5, therefore, the detailed description of the operation of the printer 6 will not be made.

First, the network MFP 7 performs the processes illustrated in Step S21 through S23. Then, the code process unit 711 and the rasterizing instruction unit 712 performs the below-described processes, instead of the processes illustrated in Step S24 through S26.

The code process unit 711 extracts the two-dimensional code 35 from the scanned image data 41, and obtains the destination information 43 from the two-dimensional code 35. Based on the destination information 43, the rasterizing instruction unit 712 obtains the attribute information 34 as the attribute information 44 from the file server 4.

The rasterizing instruction unit 712 specifies the printer 6 as the printer which has created the printed document 40 based on the obtained attribute information 44. The rasterizing instruction unit 712 transmits the raster data transmission request 45 which includes the destination information 43 and the attribute information to the printer 6. Then, the network MFP 7 performs the processes described in Step S27 and 28 to create the copied document 50.

According to the above-described embodiment, the network MFP 7 as well as the network MFP 2, in creating the copied document 50, allows the printer 6 to generate the combined raster data 47 which is the same as the combined raster data 37 printed on the printed document 40. In this way, a user can easily create the copied document 50 which is the same as the printed document 40, with the network MFP 7, which is different from the printer 6 by which the printed documents 40 is created.

The printer 6 stores the attribute information together with the original data 32 in the file server 4. In this way, the amount of data which is recorded in the attribute information 34 is not limited to the amount the two-dimensional code 35 can contain. Therefore, the printer 6 can record more information in the attribute information 34 than the printer 1.

Although the above-described embodiment refers to an example in which, in creating the copied document 50, the rasterizing instruction unit 712 obtains the attribute information 34 as the attribute information 44 from the file server 4, the present invention is not limited to such an example. For example, the rasterizing instruction unit 712 may obtain only the creation source information of the attribute information 34 stored in the file server 4. In this case, the raster data transmission request 45 is generated which includes the destination information 43 and the creation source information. After receiving the raster data transmission request 45, the data administration unit 611 of the printer 6 obtains the original data 32 and the type and used font information of the attribute information 34 based on the destination information 43.

Although the above-described embodiment refers to examples in which the printed document 40 is created by the printers 1 and 6, the present invention is not limited to such an example. For example, the network MFP 2 or 7 may create the printed document 40. In this case, the control unit 21 of the network MFP 2 is provided with the data administration unit 111, the attribute information generation unit 112, the code creation unit 113, and the image process unit 114. The control unit 21 of the network MFP 7 is provided with the data administration unit 611, the attribute information generation unit 112, the code creation unit 613, and the image process unit 114.

Although the above-described embodiment refers to an example in which the two-dimensional code 35 is printed on the copied document 50, the present invention is not limited to such an example. For example, the two-dimensional code 35 may not be printed on the copied document 50. In this case, the printers 1 and 6 may omit the process illustrated in Step S35 and transmit the raster data 36 as the raster data transmission response 46 to the network MFPs 2 or 7.

Although the above-described embodiment refers to an example in which the printing data 31 is composed of a single page, the present invention is not limited to such an example. The printing data 31 may be composed of a plurality of pages. In this case, the printer 1 or 6 may print the two-dimensional code 35 only on the first page of the printed document 40, or the printer 1 or 6 may print the two-dimensional code 35 on every page of the printed document 40. In this way, the network MFP 2 or 7 can create the copied document 50 without scanning every page of the printed document 40.

While the present invention has been described with respect to embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming device connected to a network, comprising:
a data administration unit arranged to store printing data in a memory unit and generate identification data that identifies the printing data stored in the memory unit;
a creation source information generation unit arranged to generate information that specifies the own device as a creation source;
a raster data generation unit arranged to rasterize the printing data and generate raster data with the creation source information which includes the rasterized printing data, the identification data and the creation source information; and
a printer unit arranged to print the raster data with the creation source information on a printing paper.

2. The image forming device according to claim 1, further comprising:
a setting information generation unit arranged to generate setting information for generating the raster data with the creation source information,
wherein the raster data with the creation source information includes the setting information.

3. An image forming device connected to a network, comprising:
a data administration unit arranged to store printing data in a memory unit and generate identification data that identifies the printing data stored in the memory unit;
a creation source information generation unit arranged to generate information that specifies the own device as a creation source and store the information in the memory unit, the creation source information being associated with the identification data;
a raster data process unit arranged to rasterize the printing data and generate raster data with the identification data which includes the rasterized printing data and the identification data; and
a printer unit arranged to print the raster data with the identification data on a printing paper.

4. The image forming device according to claim 3, further comprising:
a setting information generation unit arranged to generate setting information for generating the raster data with the identification data associated with the identification data and store the setting information in the memory unit.

5. The image forming device according to claim 2, further comprising:
an original data obtaining unit arranged to receive the identification data from a communication device connected via the network and obtain the printing data stored in the memory unit as original data based on the received identification data;
a setting information obtaining unit arranged to obtain the setting information associated with the identification data;
a replicated data generation unit arranged to rasterize the original data based on the obtained setting information and generate replicated raster data including the rasterized original data; and
a transmitting unit arranged to transmit the replicated raster data to the communication device.

6. The image forming device according to claim 4, further comprising:
an original data obtaining unit arranged to receive the identification data from a communication device connected via the network and obtain the printing data stored in the memory unit as an original data based on the received identification data;
a setting information obtaining unit arranged to obtain the setting information associated with the identification data;
a replicated data generation unit arranged to rasterize the original data according to the obtained setting information and generate replicated raster data including the rasterized original data; and
a transmitting unit arranged to transmit the replicated raster data to the communication device.

7. An image forming device connected to a printing device via a network, comprising:
a scanner unit arranged to scan a printed paper on which printing data and identification data that identifies the printing data are printed to generate scanned image data;
an attribute information obtaining unit arranged to obtain the identification data from the scanned image data and then obtain creation source information that specifies the printing device, associated with the identification data;
a rasterizing instruction unit arranged to specify the printing device based on the obtained creation source information and ask the printing device to generate raster data including the rasterized printing data by transmitting the obtained identification data to the printing device; and
a printer unit arranged to receive the raster data generated by the printing device and print the received raster data.

8. The image forming device according to claim 7, wherein the attribute information obtaining unit includes a setting information obtaining unit arranged to obtain setting information for a process of rasterizing of the printing data, associated with the identification data and
the rasterizing instruction unit includes a transmitting unit arranged to transmit the identification data and the setting information to the printing device in order to make a request for generating the raster data by the printing device.

9. A control method of an image forming device connected to a network, comprising the step of;
storing printing data;
generating identification data that identifies the stored printing data;
generating creation source information that specifies the own device as a creation source;
rasterizing the printing data and generating the raster data with the creation source information including the rasterized printing data, the identification data, and the creation source information; and
printing the raster data with the creation source information on a printing paper.

10. The image forming device according to claim 5, wherein the identification information includes destination information which indicates the destination to which the original data is stored.

11. The image forming device according to claim 5, wherein the setting information includes type information which indicate a format of the original data.

12. The image forming device according to claim 6, wherein the identification information includes destination information which indicates the destination to which the original data is stored.

13. The image forming device according to claim 6, wherein the setting information includes type information which indicate a format of the original data.
